(19) United States
(12) Patent Application Publication
(10) Pub. No.: US 2015/0029146 A1
(43) Pub. Date: Jan. 29, 2015

(54) CAPACITIVE TOUCHSCREEN DEVICE WITH MULTI-TOUCHSCREENS

(71) Applicant: THALES, Neuilly sur Seine (FR)

(72) Inventors: Philippe CONI, Saint Jean d'Illac (FR); Frederic Renaud, Mios (FR); Yves Sontag, Bordeaux (FR)

(21) Appl. No.: 14/340,515

(22) Filed: Jul. 24, 2014

(30) Foreign Application Priority Data
Jul. 26, 2013 (FR) 1301798

(51) Int. Cl. G06F 3/044

(52) U.S. Cl. CPC G06F 3/044
USPC 345/174

(57) ABSTRACT

The general field of the invention is that of devices with touchscreen of the capacitive type comprising two matrix touch pads connected to an electronic assembly comprising emission and receiving means. The emission means generate a plurality of emission signals at various frequencies. A period equal to the inverse of the said frequency being associated with each frequency, the values of the frequencies are such that there exist a plurality of integer numbers each associated with a frequency and with a period such that the product of each integer number with the associated period is a constant product. The receiving means comprise a synchronous amplitude demodulation arranged in such a manner as to perform the multiplication of the received signal by a plurality of periodic functions representative of each frequency, the multiplied signals obtained being integrated over an identical period of time corresponding to the said constant product, each signal thus integrated being representative of a received signal at a single given frequency.

### BACKGROUND OF THE INVENTION

1. Technical Field of the Invention

The field of the invention is that of touchscreens using capacitive detection and, more particularly, touchscreens known as “multi-touch screens” allowing the detection of two simultaneous touch operations. This function is essential for performing for example “zooms” or image rotations.

2. Description of the Prior Art

The more particular field of the invention is that of the robustness to failures of the said touchscreen. This invention may be applied in various types of use but it is particularly well adapted to the constraints of the aeronautical field and of aircraft instrument panels where the detection and the correction of malfunctions is essential in order to ensure flight safety.

The capacitive detection referred to as “projected detection” consists in forming a detection matrix composed of conducting rows and columns arranged so as to detect the local variations in capacitance introduced by the proximity of the fingers of the user or of any other designated object as long as it is electrically conducting. The technology known as projected capacitive technology may be divided into two main variants which are:
“Self-capacitive” detection which consists in reading the rows then the columns of the network of touch points of the matrix;
Detection known as “Mutual capacitive” detection consisting in reading each intersection of the network of touch points of the matrix.

The principle of operation of a touch pad of a tap detection system in “self-capacitance” mode is as follows. When a row or a column of this touch pad is excited at a given frequency, the capacitance seen on this row or this column is measured. In the case of a tap, the common mode capacitance on the row or the column is very slightly increased. This very slight variation is detected by virtue of an algorithm having saved the idling situation in memory while at the same time eliminating the background noise.

In this type of tap detection system by self capacitance, the rows then the columns are scanned successively. One of the drawbacks of this type of device is that the loss of a row or of a column leads to the loss of functionality of the entire device. When such a touchscreen device is installed on an aircraft instrument panel display screen, which only comprises a limited number of display screens, the loss of a touchscreen device and hence of the corresponding display screen poses significant problems this availability.

In order to solve this problem, the conventional solution consists in separating a large touchscreen into two, totally independent, touchscreen surfaces. Thus, in the case of a loss of one of the two touchscreen surfaces, the second touchscreen surface remains operational and can potentially be reconfigured in order to provide, partially or fully, the tasks of the faulty touchscreen surface. However, this technique suffers from a significant drawback. The touchscreens of the prior art are not immune from the electric fields generated by a neighbouring touchscreen device, which makes it necessary to maintain a minimum distance between two screens and accordingly prohibits the implementation of a single secure screen disposing of two segregated touchscreen areas operating at the same or at neighbouring measurement frequencies. This drawback is illustrated in FIG. 1 which shows two touchscreens T1 and T2 side by side. If a transmission/received signal S is injected at a certain frequency into the touchscreen T1, the receiving means of the touchscreen T2 receive an interference signal SP at the said frequency.

### SUMMARY OF THE INVENTION

The device according to the invention does not suffer from this drawback. It allows the simultaneous use of two touchscreens, including where they are formed on the same substrate, while at the same time conserving the advantage of using neighbouring measurement frequencies. For this purpose, the device according to the invention implements signals emitted at orthogonal frequencies and a synchronous demodulation using this property. More precisely, the subject of the invention is a touchscreen device comprising at least two matrix touch pads, each touch pad comprising a plurality of conducting rows and of conducting columns, the said pads being connected to an electronic assembly comprising means for emitting and for receiving electrical signals from periodic measurements, the emission means generating at least one first emission signal at a first frequency intended for the first touch pad and a second emission signal at a second frequency intended for the second touch pad, the receiving means being arranged so as to process a received signal comprising the first frequency and the second frequency;

Characterized in that,

a first period equal to the inverse of the said first frequency being associated with the first frequency, a second period equal to the inverse of the said second frequency being associated with the second frequency, the values of the frequencies are such that there exist two integer numbers that are non-multiples of each other such that the product of the first integer number with the first period is equal to the product of the second integer number with the second period and,

the receiving means comprise a synchronous amplitude demodulation configured in such a manner as to form the multiplication of the received signal with four different sine and cosine periodic functions, the first two functions being at the first frequency and the second two functions being at the second frequency, the four multiplied signals obtained being integrated over an identical period of time corresponding to the said product, the signals thus integrated being representative of a first received signal at the first frequency and only at the first frequency and of a second received signal at the second frequency and only at the second frequency.

Advantageously, the two touch pads of the device are formed on the same transparent substrate.

Advantageously, two touch pads of the device are formed on two different transparent substrates.

Advantageously, the touchscreen device comprises a device for manual or automatic selection of the first frequency and of the second frequency.

Advantageously, the selection device comprises means for recognizing the emitted frequencies in its immediate environment, the selection of the first frequency and of the second frequency depending on the said recognition.

Advantageously, the selection of the first frequency automatically leads to that of the second frequency, the first frequency and the second frequency being coupled.

Advantageously, the emission means generate a plurality of emission signals at different frequencies, a period equal to the inverse of the said frequency being associated with each frequency, the values of the frequencies are such that there exist a plurality of integer numbers that are non-multiples of each other, each number being associated with a frequency and with the corresponding period such that the product of each integer number with the associated period is a constant product, and

the receiving means comprise a synchronous amplitude demodulation arranged in such a manner as to perform the multiplication of the received signal with a plurality of different sine and cosine periodic functions representative of each frequency, the multiplied signals obtained being integrated over an identical period of time corresponding to the said constant product, each signal thus integrated being representative of a received signal at a given frequency and only at this frequency.

Advantageously, the touchscreen device comprises at least one display device associated with the matrix touch pads.

### BRIEF DESCRIPTION OF THE FIGURES

The invention will be better understood and other advantages will become apparent upon reading the description that follows presented by way of non-limiting example and thanks to the appended figures amongst which:

FIG. 1, already commented on, shows a device with two touchscreens according to the prior art;

FIG. 2 shows the schematic diagram of the receiving means in a device according to the invention;

FIGS. 3 and 4 show the principle of orthogonal frequencies.

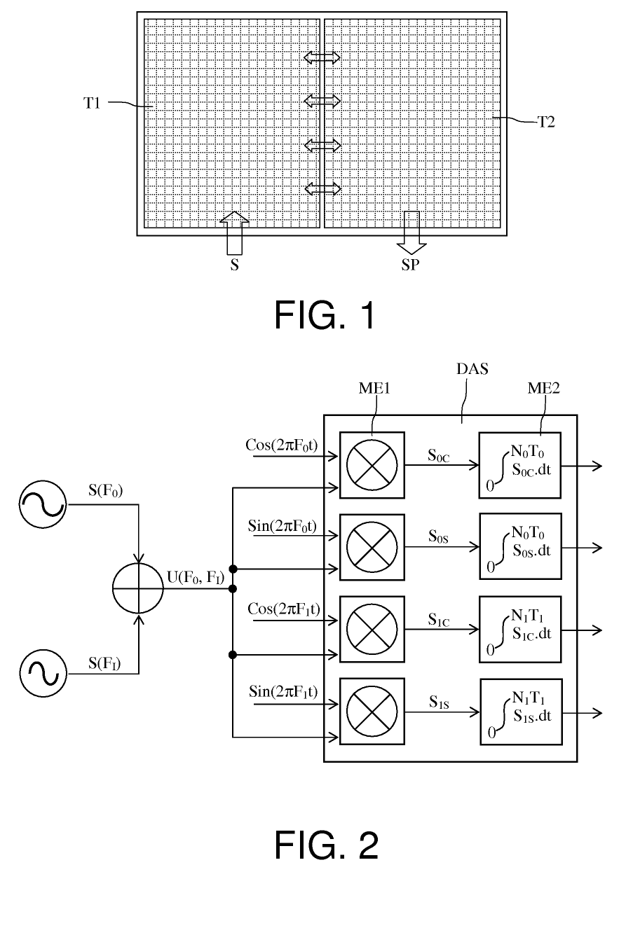

### DETAILED DESCRIPTION

As has already been said, the object of the invention is to be able to make two touch pads, disposed very close to each other or formed on the same substrate, operate without the electronic operation of the first touch pad interfering with that of the second. If the two pads have to operate simultaneously, it is of course necessary for the emission signals to be emitted at different frequencies and it is also necessary for the receiving system to be able to perfectly separate the signals received at these various frequencies. In order to provide this function, the device implements signals emitted at frequencies referred to as “orthogonal frequencies” and the receiving means comprise a synchronous amplitude demodulation operating with a specific integration time.

The principle of operation of the device is illustrated in FIG. 2 in the simple case where the emission signals of the first touch pad are emitted at a first frequency F₀ and the emission signals of the second touch pad at a second frequency F_{I}. The following will also be denoted: T₀ the period associated with the first frequency F₀, and T_{I} the period associated with the second frequency F_{I} with the conventional relationships:

T₀=1/F₀ and T_{I}=1/F_{I}

It goes without saying that this principle can readily be generalized to a plurality of frequencies.

The emission signal S0 on the first touch pad is equal to:

S0=C0 sin(2πF₀t)

The emission signal SI on the second touch pad is equal to:

SI=CI sin(2πF_{I}t)

C0 and CI being being constants

The signal received U(F₀,F_{I}) by the receiving means of the touchscreen device comprises both a signal at the first frequency and a signal at the second frequency. It therefore takes the form:

U(F₀,F_{I})=A0 sin(2πF₀t)+Ai sin(2πF_{I}t)

This received signal is transmitted to a synchronous amplitude demodulation DAS. As shown in FIG. 2, the latter comprises first electronic means ME1 arranged in such a manner as to perform the multiplication of the received signal with four different sine and cosine periodic functions, the frequency of the first two functions is equal to the frequency F₀ and the frequency of the last two functions is equal to the frequency F_{I}. By way of example, the multiplication by the function sin(2πF₀t) gives the product S_{0S} which is equal to:

S_{0S}=U·sin(2πF₀t)=A₀ sin²(2πF₀t)+Ai sin(2πFᵢt)sin(2πF₀t)

Or again:

S_{0S}=A₀/2−A₀/2 cos(4πF₀t)]+Ai/2 cos[2π(F₀−Fᵢ)t]−Ai/2 cos[2π(F₀+Fᵢ)t]

Thus, the product S_{0S} comprises a first constant term proportional to the amplitude A₀ of the received signal at the frequency F₀ and periodic terms at the frequencies (F₀−F_{I}) and (F₀+F_{I}). The interesting part of the product is, of course, the constant term. The products S_{0C}, S_{IS} and S_{IC} are calculated in the same way.

The synchronous amplitude demodulation DAS comprises second electronic means ME2 arranged in such a manner as to perform the integration of the products obtained over an identical interval of time T. It is clear that the integration of the products of the S_{0S} type is only advantageous if the integral of the variable terms is zero or virtually so. It is known that the integral of a trigonometric sine or cosine function is zero on condition that the integral is carried out over a period of time equal to an integer number of periods. The condition for the products S_{0S}, S_{0C}, S_{IS} and S_{IC} to depend on one and only one frequency is therefore obtained. This condition is the following:

N₀T₀=N_{I}T_{I}=T

N₀ and N_{I} being integer numbers

As a consequence, the emission frequencies must be chosen in such a manner that they verify this simple condition.

Starting from this equation, the minimum frequency difference Δf that has to separate two emission frequencies and which corresponds to a difference of one unit between the numbers N₀ and N_{I} is easily calculated; it is equal to Δf=1/T. Thus, if the integration time T is equal to 100 μs, the minimal interval between two emission frequencies is equal to 10 kHz.

The choice of the emission frequencies is therefore simple. Knowing a chosen integration time T, the various frequencies f are chosen in such a manner that the product f·T is an integer number, each time different and never multiples of one another.

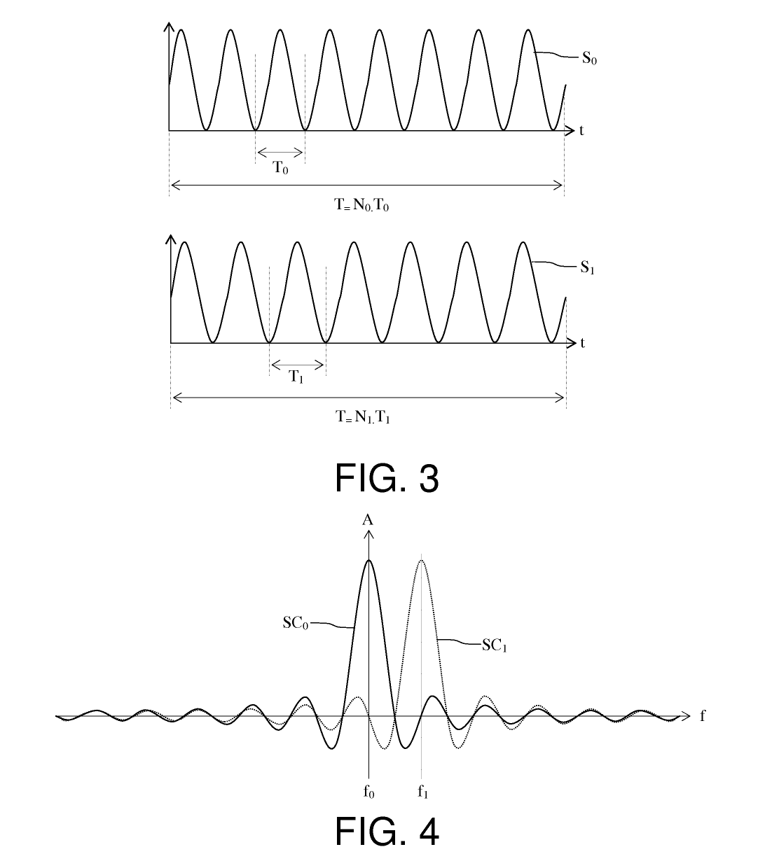

By way of example, FIG. 3 shows two signals S₀ and S₁ emitted at two frequencies f₀ and f₁ according to the invention with respective periods T₀ and T₁ as a function of the time t. The integration time is equal to T, the integer numbers N₀ and N₁ and the periods T₀ and T₁ respectively verify:

8 T₀=7 T₁=T

The signals emitted during the integration time have a frequency distribution shown in FIG. 4 which represents the amplitude A of the frequency signal as a function of the frequency f. This frequency distribution corresponds to the Fourier transform of the signal. It is a sinc function whose central peak width is equal to 1/T. The first sinc function SC₀ is centred on the sinc function SC₁ frequency and the second sinc function SC₁ is centred on the frequency f₁. As can be seen in FIG. 4, at the frequency f₀, the sinc function SC₁ is perfectly zero and vice versa, thus showing that there is no parasitic signal from one frequency on the other.

The touchscreen device is designed to operate in an environment which may comprise other devices operating in the same ranges of frequency. In order to avoid being interfered with by these external frequencies, the device according to the invention can comprise a device for manual or automatic selection of the first frequency and of the second frequency.

In this case, the selection device can comprise means for recognizing the emitted frequencies in its immediate environment, the selection of the first frequency and of the second frequency depending on this recognition. Advantageously, the selection of the first frequency can automatically lead to that of the second frequency, the first frequency and the second frequency being coupled.

Generally, the touchscreen device comprises a single display device associated with the matrix touch pads according to the invention. These display devices are used, for example, on aircraft instrument panels.

1. Device with touchscreen comprising at least two matrix touch pads, each touch pad comprising a plurality of conducting rows and of conducting columns, the said pads being connected to an electronic assembly comprising means for emitting and for receiving electrical signals from periodic measurements, the emission means generating at least one first emission signal at a first frequency intended for the first touch pad and a second emission signal at a second frequency intended for the second touch pad, the receiving means being arranged so as to process a received signal comprising the first frequency and the second frequency, in which
a first period equal to the inverse of the said first frequency being associated with the first frequency, a second period equal to the inverse of the said second frequency being associated with the second frequency, the values of the frequencies are such that there exist two integer numbers that are non-multiples of each other such that the product of the first integer number with the first period is equal to the product of the second integer number with the second period, and
the receiving means comprise a synchronous amplitude demodulation arranged in such a manner as to perform the multiplication of the received signal with four different sine and cosine periodic functions, the first two functions being at the first frequency and the second two functions being at the second frequency, the four multiplied signals obtained being integrated over an identical period of time corresponding to the said product, the signals thus integrated being representative of a first received signal at the first frequency and only at the first frequency and of a second received signal at the second frequency and only at the second frequency.

2. Device with touchscreen according to claim 1, in which the two touch pads of the device are formed on the same transparent substrate.

3. Device with touchscreen according to claim 1, in which the two touch pads of the device are formed on two different transparent substrates.

4. Device with touchscreen according to claim 1 comprising a device for manual or automatic selection of the first frequency and of the second frequency.

5. Device with touchscreen according to claim 4, in which the selection device comprises means for recognizing the emitted frequencies in its immediate environment, the selection of the first frequency and of the second frequency depending on the said recognition.

6. Device with touchscreen according to claim 4, in which the selection of the first frequency automatically leads to that of the second frequency, the first frequency and the second frequency being coupled.

7. Device with touchscreen according to claim 1, in which
the emission means generating a plurality of emission signals at different frequencies, a period equal to the inverse of the said frequency being associated with each frequency, the values of the frequencies are such that there exist a plurality of integer numbers that are non-multiples of each other, each number being associated with a frequency and with the corresponding period such that the product of each integer number with the associated period is a constant product, and
the receiving means comprise a synchronous amplitude demodulation arranged in such a manner as to perform the multiplication of the received signal by a plurality of different sine and cosine periodic functions representative of each frequency, the multiplied signals obtained being integrated over an identical period of time corresponding to the said constant product, each signal thus integrated being representative of a received signal at a given frequency and only at this frequency.

8. Device with touchscreen according to claim 1 comprising at least one display device associated with the matrix touch pads.
